(19) United States
(12) Patent Application Publication
(10) Pub. No.: US 2025/0310297 A1
(43) Pub. Date: Oct. 2, 2025

(54) Interface Discrimination for Communication with Network Address Assignment Server

(71) Applicant: Arista Networks, Inc., Santa Clara, CA (US)

(72) Inventors: Eamon Doyle, Dublin (IE); Saurabh Singhal, Bangalore (IN)

(21) Appl. No.: 18/617,925

(22) Filed: Mar. 27, 2024

(51) Int. Cl. H04L 61/5014

(52) U.S. Cl. CPC H04L 61/5014

(57) ABSTRACT

A network device may transmit a request message on a plurality of network interfaces destined for one or more network address assignment servers communicatively coupled to the network interfaces. The network device may maintain interface discrimination information that identifies one or more network interfaces on which previously received response messages failed to facilitate the completion of a device operation. The network device may send subsequent request message(s) based on the interface discrimination information.

### BACKGROUND

This relates to network devices, and more particularly, to network devices configured to communicate with a network address assignment server.

In one illustrative system, a network device may be an initially un-provisioned network device configured to perform a self-provisioning operation by communicating with the network address assignment server.

### BRIEF DESCRIPTION OF THE DRAWINGS

FIG. 1 is a diagram of an illustrative network in which a network device is configured to communicate with network address assignment server(s) in accordance with some embodiments.

FIG. 2 is a diagram of an illustrative network device in accordance with some embodiments.

FIG. 3 is a diagram of an illustrative network device communicating with multiple network address assignment servers using different device network interfaces in accordance with some embodiments.

FIG. 4 is a diagram of an illustrative initial state of interface discrimination information including an interface deny list in accordance with some embodiments.

FIG. 5 is a diagram of an illustrative state of interface discrimination information after a failure associated with the use of a particular network interface in accordance with some embodiments.

FIG. 6 is a diagram of an illustrative network device communicating with a network address assignment server using an identified subset of one or more network interfaces in accordance with some embodiments.

FIG. 7 is a diagram of illustrative interface discrimination information identifying an additional set of one or more available network interfaces in accordance with some embodiments.

FIG. 8 is a diagram of illustrative interface discrimination information identifying a list of inactive network interfaces in accordance with some embodiments.

FIG. 9 is a flowchart of illustrative operations for operating a network device based on interface discrimination information in accordance with some embodiments.

### DETAILED DESCRIPTION

A network can convey network traffic (e.g., in the form of packets, frames, etc.) between hosts or generally between devices in the network. To properly route and forward the network traffic, the network can include a number of network devices configured with networking data such as forwarding decision data, routing decision data, network policy information, etc. Network devices typically require provisioning and the reception of networking data to be operational within the network. To simplify the process of provisioning or configuring a network device for operation, the network device may initiate its own provisioning operation (sometimes referred to as a self-provisioning operation).

As part of the provisioning operation and/or as part of other network device operations, the network device may be configured to request and obtain information such as an information server address in a response from a network address assignment server (e.g., a server implementing DHCP (Dynamic Host Configuration Protocol) such as DHCPv4 (Dynamic Host Configuration Protocol version 4), stateful DHCPv6 (Dynamic Host Configuration Protocol version 6), and/or stateless DHCPv6). The network device may further use the information server address (e.g., a Uniform Resource Locator (URL) or web address) to access the information server. When obtained as part of the provisioning operation, the information server address may be an address of a device bootstrapping server (sometimes referred to herein as a bootstrapping information server) that stores and provides device bootstrapping information. The network device may use the device bootstrapping server address to communicate with the device bootstrapping server and receive the bootstrapping information, which is processed to perform the self-provisioning operation.

In illustrative configurations described herein as an example, multiple network address assignment servers on different networks (e.g., on different Local Area Networks (LANs), on a LAN and a Wide Area Network (WAN), etc.) may be accessible to the network device via corresponding network interfaces of the network device. However, some network address assignment servers may not provide the desired address information in their response to the network device (e.g., may provide an address that is inaccessible using the network interface generated with the network address assignment server, may not provide a URL thereby causing the network device to default to using a URI to a publicly available service, etc.).

In certain scenarios, the network device may repeatedly receive undesired address information in response from the same network address assignment server(s) despite the network device sending requests on multiple interfaces, one of which is communicatively coupled to the network address assignment server providing the desired address information. As an example, this may be caused by the network device always processing the first-received server response, which can happen to be from undesired network address assignment server(s). The repeated failures to obtain the appropriate address information may stall efforts by the network device to communicate with the information server and to complete its device operation (e.g., to complete its self-provisioning operation).

To mitigate issues with repeatedly receiving undesired responses (from the same or from multiple network address assignment servers), the network device may preferentially send network address assignment requests, at least on subsequent attempts, from a subset of all network interfaces (e.g., not all available network interfaces). To achieve this, the network device may maintain interface discrimination information on its memory circuitry, e.g., that is accessible by the processing circuitry executing the provisioning agent in the device provisioning example. After failing to complete the provisioning operation with a prior attempt of sending a network address assignment request, the network interface used in communicating with the network address assignment server in this prior attempt may be placed on an interface deny list in the interface discrimination information, thereby preventing its use in subsequent attempts of sending the network address assignment request.

Configurations in which communication with network address assignment servers are performed as part of a device provisioning operation are sometimes described herein as an illustrative example. In general, the network device may communicate with network address assignment servers outside of the context of device self-provisioning (e.g., in other contexts or as requested by other applications executing on the network device). As such, if desired, the use of interface discrimination information to communicate with network address assignment server(s) as described herein may be applicable as part of any other operations to obtain suitable server address information from network address assignment server(s).

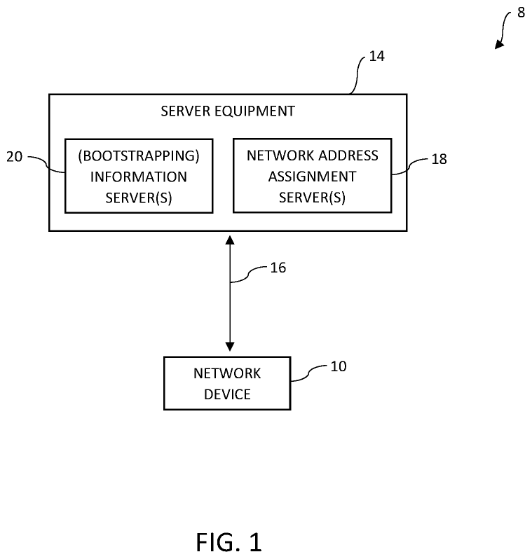

An illustrative networking system in which a network device is configured to communicate with one or more network address assignment servers is shown in FIG. 1. In particular, FIG. 1 shows an illustrative network 8 which may be of any suitable scope and/or form part of a larger network of any suitable scope. As examples, network 8 may include, be, and/or form part of one or more local segments, one or more local subnets, one or more local area networks (LANs), one or more campus area networks, a wide area network, etc. Network 8 may include any suitable number of different network devices that connect corresponding host devices of network 8 to one another. At least some of these network devices may be connected by one or more wired technologies or standards such as Ethernet (e.g., using electrical cables and/or fiber optic cables), thereby forming a wired network portion. If desired, network 8 may also include a wireless network portion coupled to the wired network portion. If desired, network 8 may include or be coupled to internet service provider networks (e.g., the Internet) or other public service provider networks, private service provider networks (e.g., multiprotocol label switching (MPLS) networks), and/or other types of networks such as telecommunication service provider networks (e.g., a cellular network based on one or more standards as described in the 3GPP specifications such as GSM, UMTS, LTE, 5G, etc.).

In general, network devices in network 8 can include any number of switches (e.g., single-layer (Layer 2) switches and/or multi-layer (Layer 2 and Layer 3) switches), bridges, routers, gateways, hubs, repeaters, firewalls, wireless access points, network devices serving other networking functions, network devices that include the functionality of two or more of these devices, management devices that control the operation of one or more of these network devices, and/or other types of network devices.

In the example of FIG. 1, the network devices of network 8 include at least network device 10, such as a multi-layer switch or another type of network device. Network 8 may also include one or more host devices or host equipment such as server equipment 14. Configurations in which network device 10 is an un-provisioned network device (e.g., not a fully provisioned network device) when initially coupled or connected to other elements of network 8 are sometimes described herein as an illustrative example.

In these configurations, network device 10 may communicate with different portions of server equipment 14 via one or more communication paths 16 in an attempt to perform a network device provisioning operation that provisions and configures device 10 itself for operation. In particular, network device 10 may communicate with a network address assignment server 18 implemented on server equipment 14 (e.g., a DHCP server such as server equipment implementing DHCPv4, implementing (stateful or stateless) DHCPv6, implementing a variation of DHCP, implementing a server that is compliant with only some portions of DHCP, and/or implementing other network address assignment protocols) to obtain a network address, or generally device configuration information, for network device 10. Additionally, the network address assignment server 18 may provide network device 10 with a network address (e.g., a URL or web address) of a bootstrapping information server 20 implemented on server equipment 14 to obtain networking data, executable files, and/or other bootstrapping data. After obtaining its network address, network device 10 may generate one or more network interfaces based on the obtained device configuration information and then access the network address of the device bootstrapping server 20, using the one or more network interfaces, to obtain networking data, executable files, and/or other bootstrapping data.

Network device 10 may be considered fully provisioned and ready to perform networking operations (e.g., routing protocols, traffic routing, traffic forwarding, etc.) after successfully executing the obtained executable files, storing the obtained networking data, and/or generally processing the provisioning information, as examples. While both shown in FIG. 1 to be within server equipment 14, servers 18 and 20 may be implemented on distinct and separate pieces of server computing equipment (e.g., on different processing circuitry or sets of processors, using different storage circuitry accessible by the corresponding processing circuitry, on the same or different server racks, etc.) at server equipment 14 or may be implemented on shared computing equipment (e.g., the same processing circuitry or set of processors, using the same storage circuitry accessible by the processing circuitry, etc.) at server equipment 14. Servers 18 and 20 may be implemented at different sites or generally on different network portions of network 8 (e.g., on different local segments) or may be implemented at the same site (e.g., on the same local segment or different local segments).

Communication paths 16 communicatively coupling network device 10 to servers 18 and 20 may be implemented using network paths of network 8. These network paths may include direct cable connections with or without intervening network devices. In other words, each path 16 may span across portions of network 8 (e.g., one or more network devices therein) to provide the connectivity illustrated in FIG. 1. While shown in FIG. 1 as a single arrow, multiple (different) paths may communicatively couple network device 10 to server 18 and/or server 20.

In one illustrative arrangement, network device 10 may lack a direct connection to server equipment 14 and any connection between network device 10 and server equipment 14 may include a router serving as a relay device. In particular, the router may contain a relay agent executing on its processing circuitry to perform relaying of address assignment messages (e.g., DHCP messages), or generally network device request and server response messages as described herein, for network device 10 and server equipment 14 (or more specifically, server 18). This relaying of DHCP messages and/or other types of messages occurs prior to device 10 having or being assigned a network address and thus will differ from normal packet forwarding (e.g., forwarding of packets that identify the network address of device 10). If desired, other routers and/or network devices may also serve as relay devices to relay DHCP messages and/or other messages between device 10 and server equipment 14 (e.g., server 18).

Configurations in which network device 10 communicates with network address assignment server 18 to obtain address information of bootstrapping information server 20 and to facilitate a device provisioning operation are sometimes described herein as an example. If desired, the embodiments described herein may similarly be applicable to network device 10 communicating with network address assignment server 18 to obtain address information of other types of information server 20 and to facilitate other operations. As another illustrative example, in addition to or instead of being configured to perform the device provisioning operation, network device 10 may be configured to perform a clock synchronization operation (e.g., using Network Time Protocol (NTP)). Configured in this manner, network device 10 may communicate with network address assignment server 18, which may provide the network device with address information (e.g., a URL) of an additional information server 20 to facilitate the desired operation (e.g., a clock synchronization operation) to be performed.

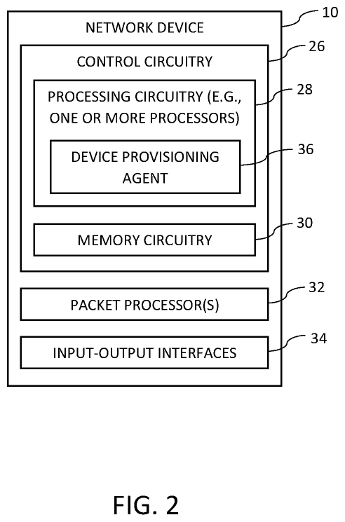

FIG. 2 is a diagram of an illustrative network device such as network device 10 in FIG. 1. In some configurations described herein as an illustrative example, network device 10 may be an un-provisioned multi-layer switch or other type of network device that automatically initiates a device provisioning operation to provision itself after being introduced to network 8 in FIG. 1 (e.g., after being communicatively coupled to components of network 8 such as a router and/or server equipment 14).

As shown in FIG. 2, network device 10 may include control circuitry 26 having processing circuitry 28 and memory circuitry 30, one or more packet processors 32, and input-output interfaces 34 (sometimes referred to as network interfaces) mounted within a housing of network device 10. If desired, the housing may include an exterior cover (e.g., a plastic exterior shell, a metal exterior shell, or an exterior shell formed from other rigid or semi-rigid materials) and/or a supporting substrate that provide structural support and/or protection for the components of network device 10 mounted within and/or on the housing. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 28 may include one or more processors such as central processing units (CPUs), graphics processing units (GPUs), microprocessors, general-purpose processors, host processors, coprocessors, microcontrollers, digital signal processors, programmable logic devices such as field programmable gate array (FPGA) devices, application specific system processors (ASSPs), application specific integrated circuit (ASIC) processors, and/or based on other types of processors.

Processing circuitry 28 may run (e.g., execute) a network device operating system and/or other software/firmware that is stored on memory circuitry 30. Memory circuitry 30 may include one or more non-transitory (tangible) computer-readable storage media that store the operating system software and/or any other software code, sometimes referred to as program instructions, software instructions, software, data, instructions, or code. As an example, the transmission, reception, and/or processing of communication with device network address assignment server(s) described herein may be stored as (software) instructions on the one or more non-transitory computer-readable storage media (e.g., in portion(s) of memory circuitry 30 in network device 10). The corresponding processing circuitry (e.g., one or more processors of processing circuitry 28 in network device 10) may process or execute the respective instructions to perform the transmission, reception, and/or processing of communication with device network address assignment server(s). Memory circuitry 30 may be non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry. Processing circuitry 28 and memory circuitry 30 as described above may sometimes be referred to collectively as control circuitry 26 (e.g., implementing a control plane of network device 10).

As other illustrative operations in addition to operations performed in connection with communication with device network address assignment server(s) 18 (e.g., as part of a device provisioning operation), processing circuitry 28 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 32, may store packet forwarding information, may execute packet processing software, and/or may execute other software instructions that control the functions of network device 10 and the other components therein. Some of these operations such as those associated with routing policy management software, routing protocol agents or processes, routing information base agents, and packet processing software may occur after the device provisioning operation has successfully completed.

Packet processor(s) 32 may be used to implement a data plane or forwarding plane of network device 10. Packet processor(s) 32 may include one or more processors such as central processing units (CPUs), graphics processing units (GPUs), microprocessors, general-purpose processors, host processors, coprocessors, microcontrollers, digital signal processors, programmable logic devices such as field programmable gate array (FPGA) devices, application specific system processors (ASSPs), application specific integrated circuit (ASIC) processors, and/or other types of processors.

Packet processor 32 may receive incoming network traffic via input-output interfaces 34, parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 32 (e.g., on content-addressable memory), and/or on a portion of memory circuitry 30. Memory circuitry for packet processor 32 may similarly include volatile memory and/or non-volatile memory.

Input-output interfaces 34 (sometimes referred to herein as network interfaces) may include one or more different types of communication interfaces such as Ethernet interfaces, optical interfaces, network layer (e.g., Internet Protocol (IP) such as IPv4 and/or IPv6) interfaces, wireless interfaces such as Bluetooth interfaces and Wi-Fi interfaces, and/or other communication interfaces for connecting network device 10 to the Internet, a local area network, a wide area network, a mobile network, and/or generally other network device(s), peripheral devices, and computing equipment (e.g., host equipment such as server equipment, client devices, etc.). In illustrative configurations described herein as an example, input-output interfaces 34 may include Ethernet interfaces implemented using and therefore include (Ethernet) ports. In particular, L2 interface circuitry may be coupled to the ports to form Ethernet interfaces with the desired interface configuration. Processing circuitry 28 may further form (e.g., configure) network layer (e.g., IPv4 and/or IPv6) interfaces. The ports may be physically coupled and electrically connected to corresponding mating connectors of external equipment, when received at the ports, and may have different form-factors to accommodate different cables, different modules, different devices, or generally different external equipment.

In configurations in which network device 10 is an initially un-provisioned network device, processing circuitry 28 on network device 10 may execute a device provisioning agent 36 (sometimes referred to herein as a device provisioning process 36) that helps manage and facilitate the device self-provisioning operation described herein after the initially un-provisioned device 10 is supplied with power and is communicatively coupled to a router of network 8 and/or server equipment 14 (e.g., by having a network connection). If desired, this provisioning operation may be initiated automatically by executing agent 36 based on one or more criteria being met. The one or more criteria can include network device 10 being connected to a power source, network device 10 being coupled to one or more elements of network 8, network device 10 lacking an initial configuration, network device 10 receiving one or more user inputs such as the pressing of a button, the providing of a key or other security element, or generally any specified input via a user interface, and/or other suitable provisioning criteria. Configured in this manner, network device 10 may sometimes be referred to herein as a network device configured for secure zero touch provisioning, zero touch provisioning, one touch provisioning, or minimal touch provisioning.

As part of the device provisioning operation, device 10 (e.g., device provisioning agent 36) may obtain the device configuration information such as the network (e.g., IP) address of network device 10. Processing circuitry 28 may use the obtained device configuration information to form one or more network interfaces 34 (e.g., one or more IPv4 or IPv6 interfaces) for device 10. Processing circuitry 28 may obtain an address of (bootstrapping) information server 20 from a network address assignment server 18. Processing circuitry 28 may subsequently communicate with bootstrapping information server 20 to obtain bootstrapping data (e.g., executable files, networking data such as routing and forwarding decision data, network policy information, etc., and generally other types of bootstrapping data).

In other illustrative configurations, processing circuitry 28 may execute a clock synchronization process to perform a clock synchronization operation with (time) information server 20 (FIG. 1), after obtaining an address of information server 20 from a network address assignment server 18.

Processing circuitry 28 may execute device provisioning agent 36 by executing software instructions stored on memory circuitry 30. While device provisioning agent 36 is described to perform respective parts of the device provisioning operation for provisioning device 10, this is merely illustrative. Processing circuitry 28 may be organized in any suitable manner (e.g., to execute any other agents or processes instead of or in addition to device provisioning agent 36) to perform each part of the device provisioning operation. Accordingly, processing circuitry 28 may sometimes be described herein to perform the device provisioning operation instead of specifically referring to the one or more agents, processes, and/or kernel executed by processing circuitry 28.

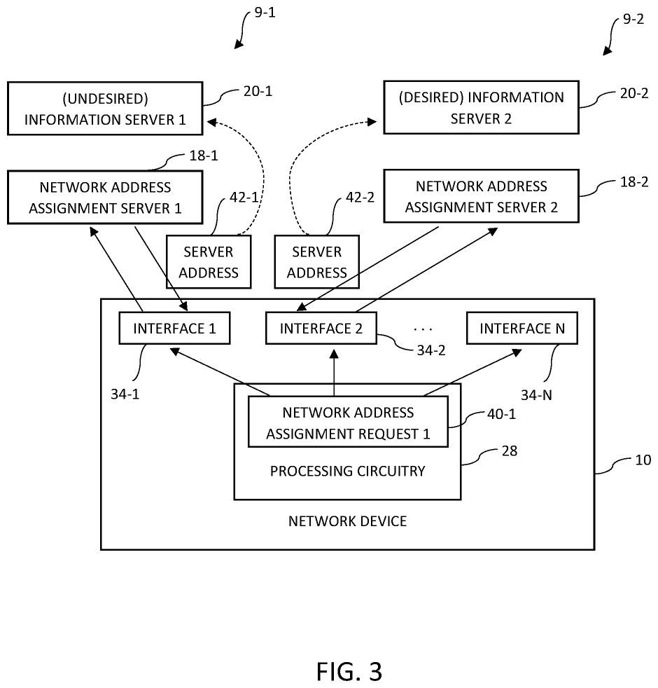

In certain configurations of network 8, multiple network address assignment servers 18 on multiple network portions of network 8 may be accessible by network device 10 via corresponding network interfaces 34 of network 10. However, some network address assignment servers 18 may not provide the appropriate address information for the desired information server 20. As examples, these undesired network address assignment servers 18 may provide a URL to a (bootstrapping) information server 20 that is not accessible by network device 10 over the configured network interface(s) 34, may not provide a URL thereby causing device provisioning agent 36 to default to using a Uniform Resource Identifier (URI) to a publicly available service, etc. In particular, FIG. 3 is a diagram of an illustrative network configuration in which network device 10 is communicatively coupled to at least two network address assignment servers 18.

In the example of FIG. 3, network device 10 may include any (N) number of network interfaces 34-1, 34-2, . . . 34-N (e.g., N instances of interfaces 34 in FIG. 2). Processing circuitry 28 for network device 10 may generate a first instance of a network address assignment request 40-1 (or generally a request message) to be transmitted on all network interfaces 34-1, 34-2, . . . 34-N. Network interface 34-1 may be communicatively coupled to a first network portion 9-1 (e.g., a first local area network, a wide area network, etc.) that includes network address assignment server 18-1, while network interface 34-2 may be communicatively coupled to a second network portion 9-2 (e.g., another local area network) that includes network address assignment server 18-2.

In response to this first network address assignment request 40-1 received from interface 34-1, network address assignment server 18-1 may respond with a corresponding response message (e.g., a network address assignment response) containing, among other information, a server address 42-1 (e.g., a URL) of information server 20-1. The response message from server 18-1 may be received using interface 34-1. However, server 20-1 may be an undesired server, e.g., because processing circuitry 28 may be unable to access information server 20-1 to complete the provisioning, clock synchronization, and/or other operation facilitated by the information on server 20-1. This may be because interface 34-1 and/or other configured interfaces 34 are not communicatively coupled to the network on which information server 20-1 resides. In contrast, the desired response message responsive to first request message 40-1 may be a response message (e.g., a network address assignment response) from network address assignment server 18-2 received using interface 34-2. The response message from server 18-2 may contain server address 42-2 (e.g., a URL) of information server 20-2 which is accessible using network interface 34-2 (and/or other configured interface 34).

In a configuration in which processing circuitry 28 is configured to always process a first-received response message from any network address assignment server and the undesired response from network address assignment server 18-1 is always received first, network device 10 may be unable, even on subsequent attempts of sending additional instances of request message 40-1, to receive the desired response message at interface 34-2 in a timely manner (e.g., prior to receiving the undesired response from network address assignment server 18-1 at interface 34-1). The processing of the first-received response by processing circuitry 28 is merely illustrative. In other configurations, processing circuitry 28 may process the responses from network address assignment servers 18 based on other criteria and/or in accordance with any other suitable prioritization scheme. However, in above-mentioned scenario or even in more optimistic scenarios (e.g., when the undesired response from network address assignment server 18-1 is only sometimes processed and/or the desired response from network address assignment server 18-2 is coincidentally processed on subsequent attempts), network device 10 may still not receive and process the desired server response message in a deterministic or reliable manner.

To mitigate issues with repeatedly receiving undesired response messages or generally providing a scheme with which the desired server response message is reliably or deterministically processed, processing circuitry 28 may be configured to preferentially send request messages 40, at least on subsequent attempts or instances, from only a subset of all network interfaces 34 (e.g., not all of interfaces 34-1, 34-2, . . . , 34-N). To achieve this, network device 10 may maintain interface discrimination information (sometimes referred to as interface preference information) on memory circuitry 30 (FIG. 2), e.g., such that the information is accessible by processing circuitry 28 executing device provisioning agent 36 in the device provisioning scenario (or in another illustrative configuration, by processing circuitry 28 executing a clock synchronization process in the clock synchronization scenario).

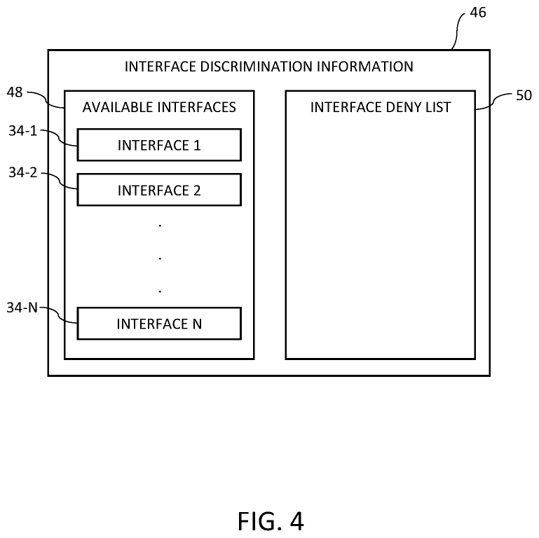

FIG. 4 is a diagram of an illustrative initial state of interface discrimination information 46. Network device 10 may store interface discrimination information 46 on memory circuitry 30 (FIG. 2). Processing circuitry 28 may maintain interface discrimination information 46 by storing and updating information identifying a set 48 of available network interfaces (e.g., on which request messages such as request message 40-1 in FIG. 3 can be sent to servers 18). Processing circuitry 28 may also maintain interface discrimination information 46 by storing and updating interface deny list 50. In particular, based on previously received and processed server responses to request messages, processing circuitry 28 may update interface deny list 50 to identify any interfaces 34 on which undesired responses (containing inappropriate server address information) were previously received. By maintaining this type of historical data associated with interface usage, processing circuitry 28 may exclude the interface(s) identified in interface deny list 50 from use on subsequent attempts (e.g., when sending subsequent instances of request message 40-1).

The example of FIG. 4 shows a first (initial) state of interface discrimination information 46. As shown in FIG. 4, available interface set 48 may identify (e.g., may include interface identifiers for) all available interfaces 34-1, 34-2, . . . , 34-N, and interface deny list 50 may be empty or may not identify (e.g., may not include interface identifiers for) any of the interfaces 34-1, 34-2, . . . , 34-N. This state of interface discrimination information 46 may reflect the state of interface discrimination information 46 prior to sending any request messages (e.g., when un-provisioned network device 10 is first connected to network 8), after sending a first round of request messages on each interface without successfully completing the device operation (e.g., a provisioning operation), and/or at any other times. Based on accessing this initial state of interface discrimination information 46 on memory circuitry 30, processing circuitry 28 may send a first instance of the request message such as message 40-1 in FIG. 3 (e.g., a network address assignment request) using all available interfaces 34-1, 34-2, . . . , 34-N in set 48 while excluding any interfaces (which in this example is none) on interface deny list 50.

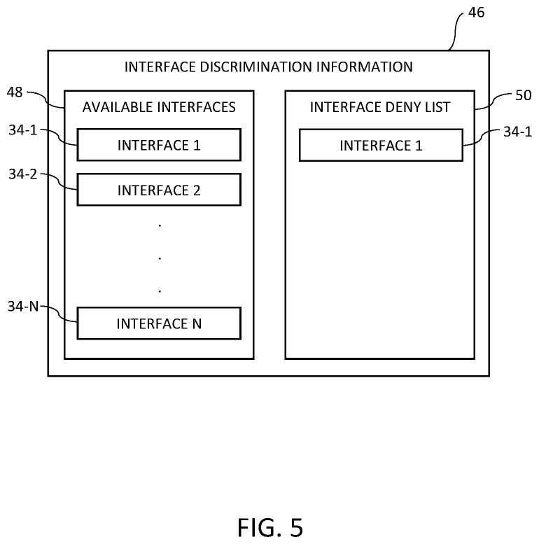

As described above in the example in connection with FIG. 3, after sending a first instance of request message 40-1 on all interfaces 34-1, 34-2, . . . , 34-N on this first attempt, network device 10 may fail to complete the desired (e.g., provisioning) operation based on the response message received at interface 34-1, e.g., containing no information server address, providing an inaccessible information server address, etc. Accordingly, processing circuitry 28 of network device 10 may update interface deny list 50 in interface discrimination information 46 to identify interface 34-1. FIG. 5 is a diagram of an illustrative updated state of interface discrimination information 46 after the inclusion of network interface 34-1 as an interface member of interface deny list 50. Interface deny list 50 identifying interface 34-1 may be indicative of interface 34-1 not yielding the desired outcome and that interface 34-1 should not be used on subsequent attempts of sending requests.

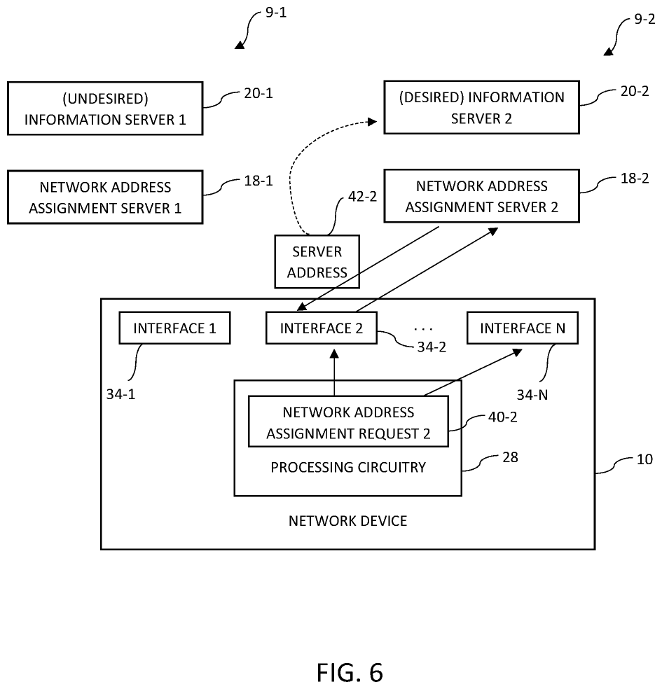

FIG. 6 is a diagram of an illustrative network device 10 configured to transmit a (second) instance of a request message (message 40-2) on selected network interfaces 34. In the example of FIG. 6, network device 10 (e.g., processing circuitry 28) may generate a second instance of request message 40-2 (e.g., the same message as request message 40-1 in FIG. 3 but sent at a later time after failing to achieve the desired outcome with message 40-1) for transmission. In particular, processing circuitry 28 may obtain the state of interface discrimination information 46 shown in FIG. 5 and may send request message 40-2 based on the updated state of interface discrimination information 46. In contrast with the first attempt illustrated in FIG. 3, on this second attempt, processing circuitry 28 may transmit request message 40-2 using all available interfaces 34-1, 34-2, . . . , 34-N in set 48 except any interface(s) on updated interface deny list 50 in FIG. 5. More explicitly, processing circuitry 28 may transmit message 40-2 using network interfaces 34-2 to 34-N but not using interface 34-1.

In one illustrative scenario, on this second attempt of sending the second instance of request message 40-2 on interfaces 34-2 to 34-N, processing circuitry 28 may receive, using interface 34-2, the desired response message from network address assignment server 18-2 containing a server address 42-2 to an accessible information server 20-2. Processing circuitry 28 may process the response message and use server address 42-2 to access and obtain (provisioning or time) information from server 20-2 to facilitate the completion of the intended (provisioning or other) operation.

In other scenarios (e.g., in an arrangement different than the arrangement is shown in FIG. 6), on this second attempt, an additional server response (e.g., from network address assignment server 18-N) received on interface 34-N (e.g., processed prior to receiving the response from server 18-2) may still fail to facilitate the completion of the (provisioning or other) operation. Accordingly, processing circuitry 28 of network device 10 may further update interface deny list 50 (from the state shown in FIG. 5) to identify interface 34-N (in addition to interface 34-1 in the example of FIG. 5). Third and/or subsequent attempts of sending additional instances of request messages may be attempted in an analogous manner (e.g., omitting transmission of the request message using any interfaces identified in interface deny list 50) until the successful completion of the (provisioning or other) operation or until all available interfaces 34-1, 34-2, . . . , 34-N identified in set 48 are identified in interface deny list 50.

If desired, when all available interfaces 34-1, 34-2, . . . , 34-N identified in set 48 are also identified in interface deny list 50, network device 10 may clear and remove at least some (e.g., all) of the identified interfaces from interface deny list 50 to facilitate further attempts of sending request messages to network address assignment server(s). If desired, other actions such as waiting a period of time prior to sending additional request messages, power cycling network device 10, sending a notification to a user, etc., may additionally or alternatively be taken when all available interfaces 34-1, 34-2, . . . , 34-N identified in set 48 are identified in interface deny list 50.

In some illustrative device configurations, the available interfaces 34-1 to 34-N (e.g., used for the first set of attempts at sending request messages as described in connection with FIGS. 3-6 and identified in set 48 of available interfaces) may represent a preferred or predetermined subset of all available or possible network interfaces 34. As an example, there may be (N+M) number of total available or possible network interfaces 34 configurable on network device 10 and network interfaces 34-1 to 34-N may be a first set of preferred network interfaces 34 for sending request messages.

Accordingly, once processing circuitry 28 has updated interface deny list 50 to include all N available interfaces 34-1 to 34-N, or once interface membership on interface deny list 50 reaches another (less than N) threshold and/or once another criterion is met, processing circuitry 28 may form and use additionally available interfaces (e.g., interfaces 34-(N+1) to 34-(N+M)) to transmit additional instances of the request message (e.g., for a second set of attempts).

In one illustrative configuration described herein as an example, the first set of available interfaces 34-1 to 34-N may each have a first (preferred and/or first-configured) interface speed while the second (additional) set of available interfaces 34-(N+1) to 34-(N+M) may each have a second (secondary and/or subsequently-configured) interface speed. As desired, the two sets of interfaces may map to different physical lanes and ports, and/or may map to shared physical lanes and ports exhibiting different interface configurations. In other words, if desired, processing circuitry 28 may re-configure interfaces 34-1 to 34-N to form network interfaces 34-(N+1) to 34-(N+M), as necessary following the use of first-configured interfaces 34-1 to 34-N.

Processing circuitry 28, on this second set of attempts using network interfaces 34-(N+1) to 34-(N+M), may update interface deny list 50 to include one or more additional available interface(s) 34-(N+1) to 34-(N+M) as desired in a similar manner as described in connection with FIGS. 3-6 and may use the state of the updated interface deny list 50 to send request messages on a subset of interfaces 34-(N+1) to 34-(N+M) in a similar manner as described in connection with FIGS. 3-6.

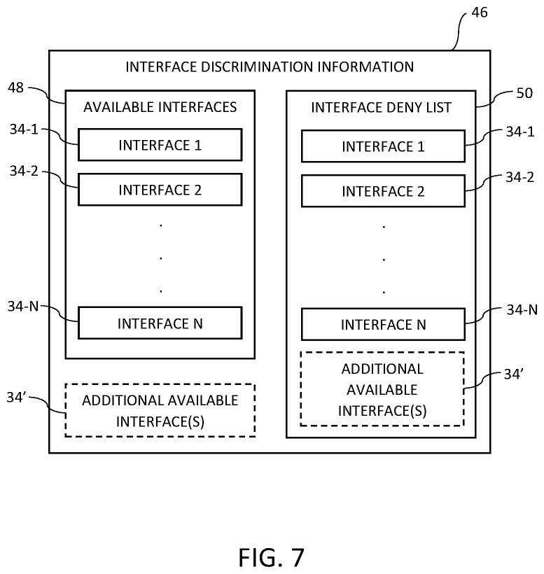

FIG. 7 is a diagram of an illustrative state of interface discrimination information 46 with the additional (re-configured) available interfaces 34′ (e.g., including interfaces 34-(N+1) to 34-(N+M) as described in the example above). These further available interfaces 34′ may be identified as another set of available interfaces in addition to the previously-configured first set interfaces identified in set 48. Because these additional interfaces 34 are configured after the first set of interfaces failed to complete the intended (provisioning or other) operation, interface deny list 50 as shown in FIG. 7 may already identify (e.g., include identifiers of) each interface in the first set of interfaces identified in set 48. As suitable, processing circuitry 28 may sequentially add one or more additional interfaces 34′ to interface deny list 50 after receiving responses on the one or more additional interfaces 34′ that also fail to provide the appropriate information server address and fail to complete the intended (provisioning or other) operation.

If desired, when all of the first and second (additional) sets of available interfaces 34-1 to 34-N and 34′ are identified in interface deny list 50, network device 10 may clear and remove at least some (e.g., all) of the interfaces from interface deny list 50 to facilitate further attempts of sending request messages to network address assignment server(s). If desired, other actions such as waiting a period of time prior to sending additional request messages, power cycling network device 10, sending a notification to a user, etc., may be additionally or alternatively taken when all of the first and second (additional) sets of available interfaces 34-1 to 34-N and 34′ are identified in interface deny list 50.

The example of two classes or sets of available interfaces (e.g., having two speeds and/or have other different interface configuration parameters) as described above is merely illustrative. If desired, processing circuitry 28 may configure (e.g., form) any suitable number of classes of available interfaces (e.g., having various speeds and/or other interface configuration parameters). Sending of request messages may be attempted using each set of these interfaces in a similar manner as described in connection with FIGS. 3-7.

In some illustrative scenarios, one or more available interfaces (e.g., interfaces 34-1 to 34-N as described in connection with FIGS. 3-6) may be in an inactive state (e.g., may be down or inoperable, may be not set up for operation even though appropriate interface hardware is available, etc.). Accordingly, in response to identifying these inactive interface(s), processing circuitry 28 of network device 10 may update interface discrimination information 46 to maintain a list of inactive interface(s). As such, when the set of available interfaces except those in the list of inactive interfaces are all identified in interface deny list 50, processing circuitry 28 may be configured to update (e.g., clear or decrement) interface deny list 50 and/or use another set of available interfaces (e.g., as described above in connection with interfaces 34-(N+1) to 34-(N+M) or interfaces 34′ in connection with FIG. 7), rather than attempting to send request messages 40 on the available but inactive interface(s).

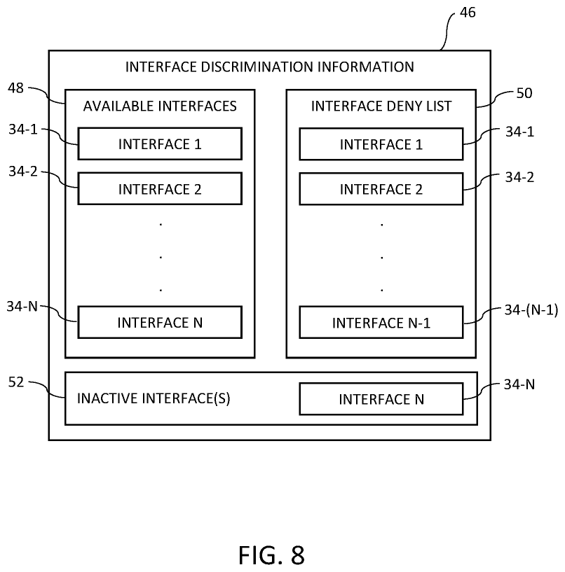

FIG. 8 is a diagram of an illustrative state of interface discrimination information 46 containing a list 52 of (available but) inactive interface(s). In the example of FIG. 8, interface 34-N may be available but in an inactive state. In particular, processing circuitry 28 of network device 10 may have updated interface deny list 50 to include interfaces 34-1 to 34-(N−1) and may have updated list 52 of inactive interfaces to identify (e.g., include an identifier of) interface 34-N. Responsive to interface discrimination information 46 being in the state shown in FIG. 8 (e.g., all available interfaces being either in interface deny list 50 or in inactive interface list 52), processing circuitry 28 of network device 10 may clear or otherwise reduce interface membership on interface deny list 50 and/or form (e.g., configure) additional available interfaces for attempting to send request messages to network address assignment server(s) 18. In some illustrative configurations, when processing circuitry 28 configures the additional available interfaces, interface 34-N may be reconfigured to be an active and available interface because interface 34-N may be inactive when configured for a first interface speed but active when configured for a second interface speed.

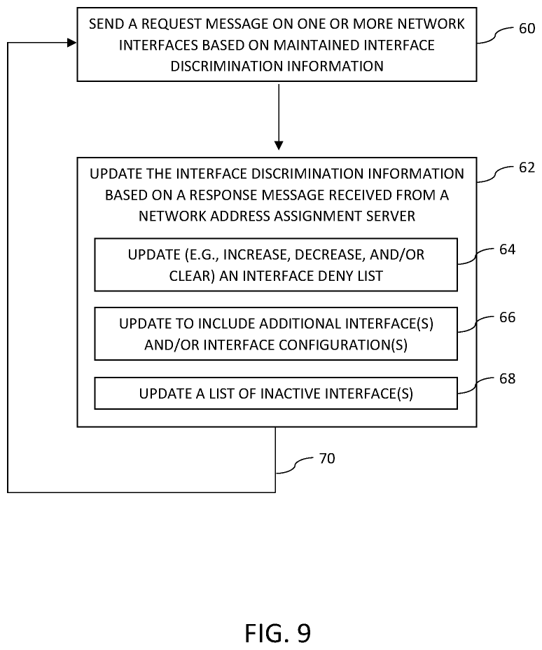

FIG. 9 is a flowchart of illustrative operations for operating a network device (e.g., of the type(s) described in connection with FIGS. 1-8, when updating stored interface discrimination information 46 between different states as described herein and/or using the stored interface discrimination information 46 as described herein).

These operations may be performed at one or more processors of processing circuitry 28 in network device 10. The illustrative operations described in connection with FIG. 9 may generally be performed by processing circuitry 28 executing software instructions stored on memory circuitry 30. If desired, one or more operations described in connection with FIG. 9 may be performed by other dedicated hardware components in device 10. In an illustrative configuration described herein as an example, the operations described in connection with FIG. 9 may be performed by device provisioning agent 36, a clock synchronization process on processing circuitry 28, a kernel executing on processing circuitry 28, or generally by processing circuitry 28 on which they are implemented.

At block 60, processing circuitry on a network device (e.g., processing circuitry 28, when executing device provisioning agent 36 and/or when performing other operations) may send a request message such as a network address assignment request, using one or more network interfaces on the network device and based on maintained interface discrimination information (e.g., a current state of the interface discrimination information maintained on memory circuitry 30 by processing circuitry 28). In particular, the processing circuitry may receive a response message (responsive to the request) from a network address assignment server using a given interface and may attempt to complete a provisioning operation based on obtaining bootstrapping information from an information server located using the response message (e.g., using an information server address in the response message). However, the provisioning operation may not have been completed by using the response message (e.g., the response message does not identify the address of an appropriate information server).

Based on the failure to complete the operation, the processing circuitry may determine that at least an additional attempt of sending another instance of the request is desired or needed. Processing subsequently may proceed to block 62. In another scenario in which the response message received at a given interface responsive to the request sent at block 60 enables the processing circuitry to complete the provisioning operation, processing may stop after block 60 and the operations described in connection with block 62 may be omitted.

At block 62, the processing circuitry may update the interface discrimination information based on a response message received from a network address assignment server (e.g., based on the response message failing to facilitate completion of a device operation).

As a first example, the operations performed at block 62 may include the processing circuitry, at block 64, updating an interface deny list (e.g., by increasing, decreasing, and/or clearing interface membership of the interface deny list). In particular, the processing circuitry may update interfaces on the interface deny list as described in connection with FIGS. 3-7.

As a second example, the operations performed at block 62 may include the processing circuitry, at block 66, updating the interface discrimination information to include additional (available) interface(s) and/or additional (available) interface configuration(s). In particular, the processing circuitry may re-configure network interfaces and update the interface discrimination information to include the newly (re-)configured network interfaces as described in connection with FIG. 7.

As a third example, the operations performed at block 62 may include the processing circuitry, at block 68, updating a list of inactive interface(s). In particular, the processing circuitry may update the list of inactive interface(s) as described in connection with FIG. 8.

Processing may further proceed back to block 60 via path 70. As such, the subsequent attempt or instance of sending the request message may be based on the most recent updates to the interface discrimination information.

The methods and operations described above in connection with FIGS. 1-9 may be performed by the components of one or more network devices and/or server or other host equipment using software, firmware, and/or hardware (e.g., dedicated circuitry or hardware). Software code for performing these operations may be stored on one or more non-transitory computer-readable storage media (e.g., tangible computer readable storage media) on one or more of the components of the network device(s) and/or server or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other host equipment (e.g., processing circuitry 28 in network device 10).

The foregoing is merely illustrative and various modifications can be made to the described embodiments. The foregoing embodiments may be implemented individually or in any combination.

What is claimed is:

1. A network device comprising:
a plurality of network interfaces;
memory circuitry configured to store an interface deny list; and
processing circuitry configured to generate a network address assignment request for transmission using a subset of the plurality of network interfaces based on the interface deny list.

2. The network device defined in claim 1, wherein the interface deny list identifies a given network interface in the plurality of network interfaces and the subset of the plurality of network interfaces excludes the given network interface.

3. The network device defined in claim 2, wherein the processing circuitry is configured to generate, prior to the generation of the network address assignment request, an additional network address assignment request for transmission using the plurality of network interfaces.

4. The network device defined in claim 3, wherein the processing circuitry failed to complete a device provisioning operation based on a response received using the given network interface, the response being responsive to the additional network address assignment request.

5. The network device defined in claim 4, wherein the processing circuitry is configured to update the interface deny list to identify the given network interface in response to failing to complete the device provisioning operation.

6. The network device defined in claim 5, wherein the processing circuitry is configured to generate the network address assignment request for transmission using the subset of the plurality of network interfaces in response to failing to complete the device provisioning operation.

7. The network device defined in claim 1, wherein the network address assignment request is a request destined for a network address assignment server.

8. The network device defined in claim 7, wherein the network address assignment request, when received by the network address assignment server, is configured to solicit a response from the network address assignment server, the response containing an address of an information server.

9. A network device comprising:
a plurality of network interfaces;
memory circuitry configured to store interface discrimination information; and
processing circuitry configured to:
obtain, using a given network interface of the plurality of network interfaces, a message from a network address assignment server;
update the interface discrimination information based on obtaining the message using the given network interface; and
send a request message based on the interface discrimination information.

10. The network device defined in claim 9, wherein the interface discrimination information identifies a set of available network interfaces in the plurality of interfaces and includes an interface deny list.

11. The network device defined in claim 10, wherein the set of available network interfaces includes the given network interface and wherein the processing circuitry is configured to update the interface discrimination information by updating the interface deny list to identify the given network interface.

12. The network device defined in claim 10, wherein the interface discrimination information identifies a list of inactive network interfaces.

13. The network device defined in claim 12, wherein the processing circuitry is configured to remove one or more network interfaces from being identified in the interface deny list in response to each network interface in the set of available network interfaces being identified in the interface deny list or in the list of inactive network interfaces.

14. The network device defined in claim 12, wherein the processing circuitry is configured to form an additional set of available network interfaces in response to each network interface in the set of available network interfaces being identified in the interface deny list or in the list of inactive network interfaces.

15. The network device defined in claim 9, wherein the processing circuitry is configured to send an additional request message prior to sending the request message and wherein the message from the network address assignment server is responsive to the additional request message.

16. A method of operating a network device, the method comprising:
transmitting a first instance of a network address assignment request on a first number of network interfaces;
receiving a network address assignment response responsive to the first network address assignment request; and
based on the received network address assignment response, transmitting a second instance of the network address assignment request on a second number of network interfaces that are fewer than the first number of network interfaces.

17. The method defined in claim 16 further comprising:
failing to complete an operation based on the received network address assignment response, wherein transmitting the second instance of the network address assignment request on the second number of network interfaces is in response to failing to complete the operation.

18. The method defined in claim 17, wherein the operation comprises a device self-provisioning operation or a time synchronization operation.

19. The method defined in claim 16, wherein the received network address assignment response lacks an information server address accessible by the network device.

20. The method defined in claim 16 further comprising:
identifying a given network interface on which the network address assignment response is received, wherein the first number of network interfaces include the given network interface and wherein the second number of network interfaces exclude the given network interface.
